(19) United States
(12) Patent Application Publication
(10) Pub. No.: US 2015/0107129 A1
(43) Pub. Date: Apr. 23, 2015

(54) HIGH-PRECISION, MULTIDIRECTIONAL AIR CROSS-STREAM GRAIN DRIER WITHOUT GRADIENTS

(71) Applicant: Otalicio Pacheco Da Cunha, Sao Leopoldo (BR)

(72) Inventor: Otalicio Pacheco Da Cunha, Sao Leopoldo (BR)

(21) Appl. No.: 14/374,206

(22) PCT Filed: Jan. 25, 2013
(86) PCT No.: PCT/BR2013/000030

§ 371 Date: Dec. 29, 2014

(30) Foreign Application Priority Data
Jan. 26, 2012 (BR) 10 2012 001750 4

(51) Int. Cl. F26B 17/12

(52) U.S. Cl. CPC F26B 17/12
USPC 34/168

(57) ABSTRACT

A high-precision, multidirectional air cross-stream grain drier without gradients comprises a continuous drier (1) with internal paths (2) for the grain stream defined between air ducts that fractionate the drying air stream, forming drying air inlets (3) and air outlets (4) arranged in parallel on either side of the grain flow paths (2) and alternating on different levels in such a manner that air streams from the right and from the left are alternatively and successively applied to the same grain stream column, along its entire path.

### TECHNOLOGICAL SECTOR OF THE INVENTION

The invention unveiled in this descriptive report pertains in a general way to the technological sector of equipments for drying grains, and refers, in a more specific way, to the sector of crossed flow dryers.

The grain drying, after harvest, is necessary to maintain the humidity in adequate levels and impede the deterioration of the stored product. There is a large variety of methods and equipments for drying grains. The continuous flow dryers are subdivided in concurrent flow dryers of countercurrent flow, dryers in cascade, and crossed flow dryers. In the dryers of concurrent flow, the drying air and the grain flow in the same direction. In dryers of countercurrent flow, the drying air and the grain flow in opposite directions. In cascade dryers, the grain moves between multiplicities of inverted troughs of V form. In crossed flow dryers, the drying air flows perpendicularly to the grains flow.

### KNOWN STATE OF TECHNIQUE

In the present state of technique, continuous grain dryings of crossed air flow have as characteristic a crossed air flow of unidirectional drying. In the entire course of the grains in the drying chamber, these receive unidirectionally the drying air flow, not existing in any moment during their residence time a change of direction of the air flow course, what causes a medium gradient of humidity (% b.u.) around eight points (comparing the smaller humidity to the larger humidity). The humidity is measured at the dryer discharge, and the gradient value can be even larger, depending of the grains' humidity at the entrance of the dryer.

In this way, conventional grain dryers of crossed air flow are deficient in results, because a fraction of the grains exists from the dryer with high humidity, and part of the grains suffers a super-drying. The grains that exit with high humidity are subject in storage to an accelerated speed of deterioration, as their intense respiration causes their death rapidly and, consequently, their deterioration. On the other hand, grains that suffered super-drying lost water in excess and suffered burning of their dry matter, losing weight and quality to be stored as well as to be industrialized.

### NOVELTY AND OBJECTIVES OF THE INVENTION

The present invention refers to a multidirectional crossed air flow grain dryer that maintains the constructive simplicity and the low cost of a closed flow dryer; however, providing a high performance drying, without temperature gradient, and of high precision.

The proposed invention comprises fractioning air ducts of the drying air flow associated to superposed stations on their levels, which alternate air flow lines to the right or to the left, which promote the drying in one same grain flow column, intensively on its right or left entry face, always alternating the air flow course to the same grain flow column, in its entire course during their residence time.

DESCRIPTION OF THE ANNEXED DRAWINGS

So that the present invention is fully understood and taken to practice by any technician of the subject, the same will be explained in a clear and objective form, with reference to the annexed drawings, which are just an example of possible concretizations of the proposed concept, without having any intention of being limitative of the scope of the protection, in which:

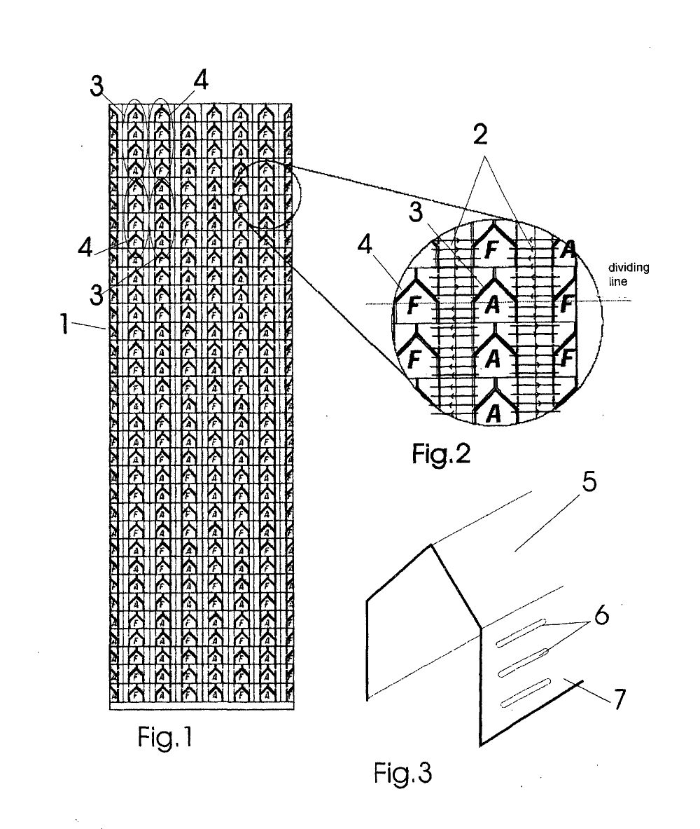

FIG. 1: Drawing in section of a first concretization of the invention.

FIG. 2: Detail in increased scale of the alternate entries and exits of air.

FIG. 3: Drawing in perspective of an air flow fractioning air duct.

FIG. 4: Drawing in section of a second concretization of the invention.

FIG. 5: Detail in increased scale of the air entries and exits on the dryer's superior stations.

FIG. 6: Detail in increased scale of the air entries and exits on the dryer's inferior stations.

### DETAILED DESCRIPTION OF THE INVENTION

The present invention refers to a multidirectional crossed air flow grain dryer of high precision without gradients, made-up by a continuous dryer (1), provided internally of courses (2) for the grain flow passage, defined between drying air flow fractioning air ducts (3) and air exits (4), positioned parallel on both sides of the grains passage courses (2), being alternatively distributed in levels, so that the same grains flow column is alternatively stroke by air flows to the right and to the left, and in this way successively during their entire course.

As it can be visualized in the annexed figures, the air flow lines are made-up by sets of various superposed air ducts in order to occur the equal fractioning of the drying air flow, therefore the directioning having the precision of the air injection in the entire course of the grains flow column through various passage stations.

In a concretization of the invention, the air flow fractioning air ducts are closed on their superior faces (5) and present air openings (6) only on the inferior side faces (7), which present greater extension whenever compared to the superior faces (5) (as represented in FIG. 5).

In another concretization, with the purpose of eliminating any humidity gradient from the grain, the inferior stations (8) present the air flow fractioning air ducts moved to the column shafts of the superior stations grains flow (2) in order to divide the grains flow in two.

It will be clear to a technician of the subject that various modifications, variables, substitutions, and additions can be performed without escaping from the scope of the present invention, just defining different concretizations of the same inventive concept.

1. MULTIDIRECTIONAL CROSSED AIR FLOW GRAIN DRYER OF HIGH PRECISION WITHOUT GRADIENTS made-up by a continuous dryer (1), internally provided with courses (2) for the passage of the grain flow, defined between drying air flow fractioning air ducts, constituting drying air entries (3) and air exits (4), positioned parallel on both sides of the grains passage course (2) characterized by the flow column to be reached alternatively by drying air flows to the right and to the left during their entire course.

2. MULTIDIRECTIONAL CROSSED AIR FLOW GRAIN DRYER OF HIGH PRECISION WITHOUT GRADIENTS of claim 1, and also characterized by drying air entries (3) and air exits (4) being distributed alternatively in sets of various air ducts in levels.

3. MULTIDIRECTIONAL CROSSED AIR FLOW GRAIN DRYER OF HIGH PRECISION WITHOUT GRADIENTS of claim 1, and also characterized by the air flow fractioning air ducts being closed on their superior faces (5), and presenting air openings (6) only on the inferior side faces (7), which present larger extension whenever compared to the superior faces (5).

4. MULTIDIRECTIONAL CROSSED AIR FLOW GRAIN DRYER OF HIGH PRECISION WITHOUT GRADIENTS of claim 1, and also characterized by the inferior stations (8) alternatively presenting the air flow fractioning air ducts moved to the grain flow column shaft (2) of the superior stations, so to divide the grains flow in two.
